(19) United States
(12) Patent Application Publication
(10) Pub. No.: US 2014/0284022 A1
(43) Pub. Date: Sep. 25, 2014

(54) PORTABLE HEATING UNIT

(71) Applicant: BLOCKHEAD INTERNATIONAL LLC, Farmington Hills, MI (US)

(72) Inventors: Reuben Maxbauer, Farmington Hills, MI (US); Samson Maxbauer, Farmington Hills, MI (US); Rachel Maxbauer, Royal Oak, MI (US)

(73) Assignee: Blockhead International LLC, Farmington Hills, MI (US)

(21) Appl. No.: 13/850,042

(22) Filed: Mar. 25, 2013

(51) Int. Cl. B60H 1/22; F24H 9/20

(52) U.S. Cl. CPC B60H 1/2218; F24H 9/2071
USPC 165/41; 392/373

(57) ABSTRACT

A portable heating system includes a rechargeable power source and a heating element electrically connected to the rechargeable power source. The system may include a power management element configured to selectively electrically connect the heating element to one of the rechargeable power source and an external power supply to power the heating element to generate heat. The system may be remotely controlled by a transmitting unit in communication with a receiving unit via a wireless communication path. The receiving unit is configured to receive command signals from a transmitting unit and communicate with a controller configured to control activation of the heating element. The power management element may be configured to monitor incoming voltage of an external power supply used to charge the rechargeable power source and to terminate use of the external power supply when the incoming voltage reaches a cut-off level.

### TECHNICAL FIELD

The present invention relates to a portable heating unit.

### BACKGROUND

A vehicle heater may take considerable time to heat the interior compartment of the vehicle, during which time occupants of the vehicle may experience discomfort due to exposure to uncomfortably cold temperatures of the vehicle compartment. Vehicles may be adapted with remote start systems, which may be used to start the engine of the unoccupied vehicle from a location remote from the vehicle, such that the vehicle engine and heater are operated to heat the interior compartment of the vehicle prior to occupying the vehicle, thereby increasing the comfort of the occupants at such time they enter the vehicle. Disadvantages of heating the vehicle by remotely starting the vehicle include vehicle fuel consumption and increased theft risk of the running vehicle. The operator must remember to leave the vehicle heater and blower of the unoccupied vehicle preset in an “on” position for the heater and blower to be activated by remote control. Vehicle remote start systems may be retrofitted to the vehicle, requiring modification of the vehicle electrical system and/or ignition system, which may affect the integrity of the vehicle electrical, ignition, safety and security systems and/or void vehicle warranty coverage of the these systems.

A non-vehicle electrical heater may be placed in the vehicle to preheat the vehicle. The non-vehicle heater may be powered directly from the vehicle battery of the non-running vehicle, which may drain the vehicle battery such that insufficient charge remains to start the vehicle. The non-vehicle heater may be powered directly from a ground supply of power, such as an electrical wall outlet, such that the use of this type of heater is limited to locations proximate the ground supply of power.

### SUMMARY

A portable heating unit which may be remotely operated is provided herein. The portable heating unit is configured to be lightweight and compact such that the portable heating unit may be carried, moved and/or repositioned by an unassisted user. The portable heating unit is powered by a rechargeable power source contained in or mounted to the portable heating unit, and the rechargeable power source and portable heating unit are configured such that the power source may be recharged by selectively electrically connecting the portable heating unit to an external power supply. In one example, the portable power supply may be a vehicle, and the portable heating unit may be electrically connected to the alternator of the vehicle to recharge the power source. In this case, the portable heating unit would be configured to be charged only while the vehicle is running, therefore eliminating the risk of draining the vehicle's battery during recharging of the rechargeable power source.

A portable heating system includes a rechargeable power source and a heating element electrically connected to the rechargeable power source. The system may include a power management element configured to selectively electrically connect the heating element to one of the rechargeable power source and an external power supply to power the heating element to generate heat. The system may be remotely controlled by a transmitting unit in communication with a receiving unit via a wireless communication path. The receiving unit is configured to receive command signals from a transmitting unit and communicate with a controller configured to control activation of the heating element. The power management element may be configured to monitor incoming voltage of an external power supply used to charge the rechargeable power source and to terminate use of the external power supply when the incoming voltage reaches a cut-off level.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a portable heating system including a portable heating unit and a transmitting unit;

FIG. 2 is a schematic side view of the portable heating unit of FIG. 1;

FIG. 3 is a schematic illustration of the transmitting unit of FIG. 1;

FIG. 4 is a schematic illustration of the portable heating unit of FIG. 1; and

FIG. 5 is a schematic illustration of a vehicle showing the portable heating unit electrically connected to a vehicle power supply.

### DETAILED DESCRIPTION

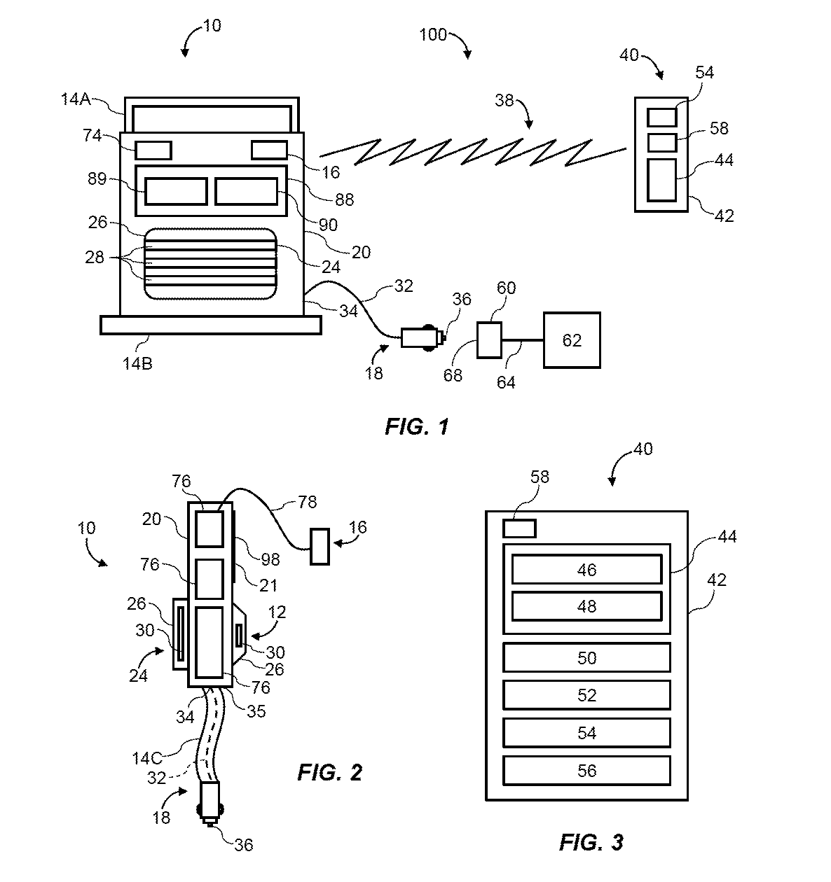

Referring to the drawings wherein like reference numbers represent like components throughout the several figures. The arrangement of the components in the schematic illustrations included herein is for purposes of disclosure and is not intended to be limiting. The elements shown in FIGS. 1-5 are not to scale or proportion and the particular dimensions and applications provided in the drawings presented herein are not to be considered limiting.

Referring to FIG. 1, a portable heating system is shown generally indicated at 100. The portable heating system 100 includes a portable heating unit generally indicated at 10 and a transmitting unit generally indicated at 40. The portable heating unit 10 includes a receiving unit 16. The receiving unit 16 and the transmitting unit 40 are configured to communicate with each other via a wireless communication path generally indicated at 38, such that the portable heating unit 10 may be remotely controlled by the transmitting unit 40. In a non-limiting example, the receiving and transmitting units 16, 40 may be configured for low power radio frequency (RF) communication. In other examples, the receiving and transmitting units 16, 40 may be configured for cellular, satellite, digital communication and the like.

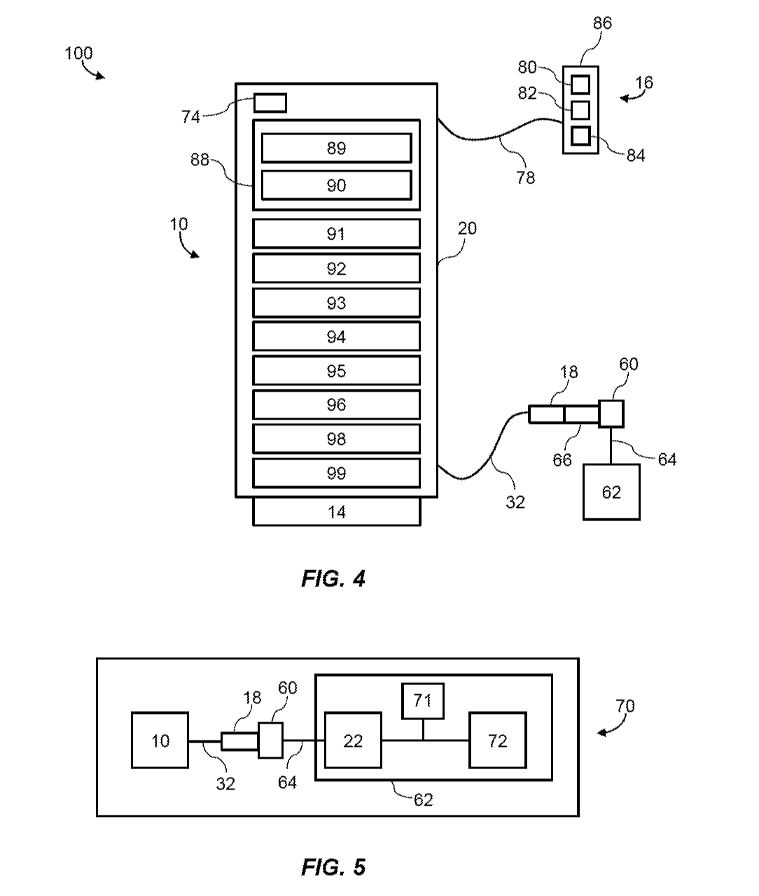

The portable heating unit 10 is shown in an example configuration in FIG. 1, in another example configuration in FIG. 2, and schematically in FIG. 4. Referring to FIGS. 1, 2 and 4, the portable heating unit 10 includes a housing 20 configured to house a heating element 91, a rechargeable power source 98 and a controller 92. The portable heating unit 10 is configured to be lightweight and manually portable, e.g., readily movable and repositionable from one location to another by an unassisted user. The portable heating unit 10 may be configured such that a user can readily lift and carry the portable heating unit 10. By way of example, the portable heating unit 10 may be configured to weigh less than 20 pounds, and preferably less than 10 pounds. It would be understood that the examples provided by the figures and the configurations and arrangements of the components of the portable heating unit 10 disclosed herein are for purposes of disclosure and are not to be considering limiting. For example, it would be understood that the components may be arranged within and/or relative to the housing 20 for efficient use of packaging space within the housing 20, for accessibility and/or ease of use by the user, for operation and/or servicing of the portable heating unit 10, to configure the portable heating unit 10 to interface with, be selectively connected to, and/or be positioned relative to another element, such as a vehicle compartment or component of a vehicle compartment, etc.

The heating element 91, rechargeable power source 98 and controller 92 of the portable heating unit 10 are in electrical communication with each other, for example, via electrical circuitry which may include a power management element 96, timing element 94 and one or more sensors 99, (see FIG. 4) configured such that the heating element 91 may be selectively actuated by the controller 92 to generate heat. The heating element 91 may be selectively electrically powered by the rechargeable power source 98 such that the portable heating unit 10 may be used as a heating source without requiring connection to a power supply external to the portable heating unit 10, wherein a power supply external to the portable heating unit 10 is referred to herein as an external power supply 62. An external power supply 62 may be, by way of non-limiting example, a vehicle power outlet connected to an alternator and/or vehicle battery, a wall outlet connected to a ground power supply, a generator, a solar panel or pad, a fuel cell, battery or battery pack of sufficient size to recharge the rechargeable power source 98, or other power supply external to the portable heating unit 10 and configurable to recharge the rechargeable power source 98. The external power supply 62 may be portable, such that the external power supply 62 and the portable heating system 100 are both portable, for example, to a location where a ground power supply or other fixed location power supply is not available. Non-limiting examples may include a parking lot, campsite, work site, an undeveloped or other geographic area not powered by an electric grid, etc. Examples of portable external power supplies 62 include vehicles including a battery, fuel cell, etc., portable generators, portable solar panels or solar cells, charged battery packs and/or fuel cells, etc.

The portable heating unit 10 may be used to generate heat in a location where it may not be desirable to use an external power supply 62, and/or where an external power supply 62 is not available or not accessible. For example, it may be desirable to use the portable heating unit 10 to generate heat to preheat the interior of a vehicle 70 (see FIG. 5) without connecting the portable heating unit 10 to a power outlet 60 electrically connected to a vehicle battery 72, due to the risk of depleting the vehicle battery 72 such that insufficient charge remains in the vehicle battery 72 for other purposes, including starting the engine (not shown) of the vehicle 70.

The power management element 96 may be configured to switch operation of the portable heating unit 10 between the rechargeable power source 98 and the external power supply 62, such that the portable heating unit 10 is electrically connected to one or the other of the rechargeable power source 98 and the external power supply 62 in operation. The power management element 96 may include a battery charger, a power inverter, a voltage sensor configured to monitor the voltage of the rechargeable power source 98 and/or the voltage of the external power supply 62, a timing circuit configured to cut off and/or trickle current coming into the portable heating unit 10 from an external power supply 62 after a fixed amount of time and/or to prevent overcharging of the rechargeable power source 98, and other circuitry as required to perform the functions of the portable heating unit 10 described herein. The example of a power management element 96 is intended to be non-limiting, and it would be understood that other configurations of the portable heating unit 10, for example, including a plurality of elements and circuitry arranged in the portable heating unit 10 to provide the functions of the power management element 96 described herein, may be used.

In the example shown, the portable heating unit 10 includes a power input 18 configured to electrically connect the power management element 96 and an external power supply 62, such that the external power supply 62 may be used to recharge the rechargeable battery 98 and/or to selectively power the portable heating unit 10 and/or the heating element 91. The power input 18 may be electrically connected to the power management element 96 via a connector 32 configured to connect the power input 18 to a power input port 34. In one example, the power input port 34 may be configured as a DC port. The power input port 34 may be electrically connected to the power management element 96 such that when the connector 32 is connected to the power input port 34, the power input 18 is electrically connected to the power management element 96. In one example, the power input 18 may be permanently connected to the portable heating unit 10 via the power input port 34. In another example, the power input port 34 may be configured to selectively receive the connector 32, such that the power input 18 can be removably connected to the portable heating unit 10, e.g., the connector 32 may be removably plugged into the power input port 34 to selectively connect the power input 18 to the portable heating unit 10. The power input port 34 and the connector 32 may be configured to provide sealed connections, e.g., a waterproof or water-resistant connections.

The connector 32 may be of any suitable configuration and/or length to provide connection of the portable heating unit 10 to the power supply 62 via the power input 18. In one example, the connector 32 may be of sufficient length to connect the power input interface 36 to a power output interface 92 located a distance from the housing 20. By way of non-limiting example, the connector 32 may be of sufficient length to extend the power input interface 36 a distance from the portable heating unit 10 positioned in a vehicle compartment to a vehicle cigarette lighter receptacle, to allow operation of the portable heating unit 10 and/or charging of the rechargeable power source 98 using the vehicle alternator as a power supply 62. In this example, the length of the connector 32 may be less than 10 feet.

In another example, the extended length of the connector 32 may be sufficient to connect a portable heating unit 10 positioned in a vehicle to a power output 60 located outside the vehicle, or alternatively, to connect the power input interface 36 of a portable heating unit 10 positioned outside of a vehicle to a vehicle power supply 62 accessible through a power output interface 68 located within the vehicle. For example, the connector 32 may be of sufficient length to extend from the portable heating unit 10 positioned outside a vehicle 70 to a power output 60 configured as a vehicle cigarette lighter receptacle accessible in the interior of the vehicle 70, to allow operation of the portable heating unit 10 outside the vehicle and/or charging of the rechargeable power source 98 using the vehicle power supply 62. In this example, the connector 32 may be at least 10 feet in length, or preferably longer than 15 feet in length.

The connector 32 may be configured with a protective cover which may be resistant to water intrusion, abrasion, etc., and the power input 18 may be configured for outdoor use. The connector 32 may be configured to facilitate routing of the connector 32 through a door interface, such as routing the connector 32 between the sealing interfaces of a door in a closed position. For example, the connector may be configured as a flat-type or ribbon-type connector.

The portable heating unit 10 and/or power input 18 may be configured such that the connector 32 is extendable from and retractable into the housing 20. In one example, the power input 18 may include a retractor element (not shown) from which the connector 32 may be extended and into which the connector 32 may be retracted for storage when not required. The housing 20 may include one or more compartments 76, configured to receive the retracted connector 32 and/or to store a non-extended portion of the connector 32 and/or the power input 18 when not in use.

The power input 18 includes a power input interface 36 configured to interface with a power output interface 68 defined by a power output 60. The power output 60 is electrically connected via a connector 64 to the power supply 62, such that when the power input 18 is connected to the power output 60, the power supply 62 is electrically connected to the portable heating unit 10. The power input interface 36 and power output interface 68 may be configured as corresponding interfaces. For example, as shown in FIGS. 1 and 2, the power input interface 36 may be configured as a cigarette lighter plug, also known as a cigarette lighter plug adapter, and the power output 60 including the power output interface 68 may be configured as a cigarette lighter receptacle, also known as a cigarette lighter socket, a 12V DC vehicle socket or a 12V auxiliary power outlet of a vehicle. Other examples of corresponding configurations of the power input and output interfaces 36, 68 include universal serial bus (USB) and micro-USB interfaces. An adapter 66 (see FIG. 4) may be used to connect the power input interface 36 and the power output interface 68. In one example, the adapter 66 may be configured as an AC/DC adapter configured to receive the power input interface 36 configured as a cigarette lighter plug, and to be pluggable into a wall socket or other ground supply of power.

The examples provided herein are not intended to be limiting, and it is understood that other configurations of the power input interface 36 and/or the adapter 66 may be used to electrically connect the portable heating unit 10 to a power supply 62. The power input interface 36 may be configured to be electrically connected to the electrical system of the vehicle 70, including a power supply 62. The power input interface 36 may be configured, in this example, as a cigarette lighter plug, a USB, or other interface corresponding to the configuration of a vehicle power access point defining a power output 60 and/or power output interface 68. The vehicle power output interface 68 may be located anywhere in the vehicle 70, including for example, in the instrument panel, in a glove compartment or other storage bin, in a rear seat console, in a door, in the trunk, in a cargo area, and/or in an engine compartment, such that the portable heating unit 10 may be located proximate a vehicle power output interface 68 located in any one of these areas for charging of the rechargeable power source 98 and/or powering operation of the portable heating unit 10 using the vehicle power supply 62. The power supply 62 may include a vehicle battery 72 (see FIG. 5) which may be accessed via a power output 60 in electrical communication with, for example, a vehicle power management system which may include, for example, an alternator 22 and/or a vehicle power control module (PCM) 71. By way of non-limiting example, the power input 18 and/or and an adapter 66 used with the power input 18 may be configured to electrically connect the portable heating unit 10 to a power supply 62 including a battery, battery pack, a fuel cell, a solar pad, a solar panel, or other solar powered power supply 62. The power input 18 and/or and an adapter 66 used with the power input 18 may be configured to electrically connect the portable heating unit 10 to a ground supply of power accessible through a wall outlet, or a generator, which may be a portable generator.

The portable heating system 100 may include a plurality of power inputs 18 which may be selectively connectable to the power input port 34, and/or may include a plurality of adapters 66, of various configurations, such that the portable heating unit 10 may be connected to different configurations of power output interfaces 68 or different types of power supplies 62 by selecting a power input 18 and/or adapter 66 for connection to the portable heating unit 10 which correspond to the power supply 62 and/or power output interface 68 to be used. As shown in FIG. 2, the housing 20 may include one or more compartments 76, which may each be enclosed by an openable or removable compartment cover, to store the power input(s) 18 and/or adapter(s) 66 when not in use.

In another example, the power input 18 may be configured as shown in FIG. 2, wherein the power input 18 includes a support member 14C operatively connected to the power input interface 36, through which the connector 32 is routed for connection to the portable heating unit 10. The support member 14C may be configured as a carrier or sleeve for receiving the power input 18, such that the power input interface 36 may be selectively and removably connected to and routed through the support member 14C for connection to the portable heating unit 10. In another configuration, the power input 18 may be integrated into the support member 14C, such that the support member 14C provides the functions of a support member and a power input. The power input 18 shown in FIG. 2 may be configured for selective connection to the portable heating unit 10 via an attachment feature 35, which may include a power input port 34 to receive the connector 32. Alternatively, the support member 14C including the power input 18 may be permanently connected to the portable heating unit 10. In the example shown, the support member 14C may be configured as an adjustable member which may be repositioned to position the housing 20 relative to the power input interface 36. For example, the support member 14C may include flexible or corrugated tubing, such as gooseneck tubing, and such that when the power input 18 is connected, e.g., plugged into the power output 60, the location and/or orientation of the housing 20 can be adjusted by repositioning the support member 14C. In a non-limiting example, the portable heating unit 10 in use in a vehicle 70 may be positioned within the vehicle interior by engaging the power input 18 configured as a cigarette lighter plug in the power outlet 60 of the vehicle, e.g., the cigarette lighter socket of the vehicle, such that the portable heating unit 10 is positioned via the support member 14C relative to the cigarette lighter socket. The portable heating unit 10 may be repositioned by adjusting the position and/or configuration of the gooseneck support member 14C, so as to direct the heat air stream output from the air outlet 24 within the vehicle interior as desired. It would be understood that the support member 14C and power input 18 may be engaged with the vehicle power output 60 to position the portable heating unit 10 in the interior of the vehicle 70 without requiring power to flow from the vehicle power supply 62 to the portable heating unit 10 and/or operation of the vehicle 70, where in this use the portable heating unit 10 would be operated using the rechargeable power source 98 only.

The example of an adjustable support member 14C including gooseneck tubing is not intended to be limiting, and other configurations of adjustable support members 14C are usable, including, for example, a support member 14C which may repositioned by bending, hinging, telescoping, tilting, rotating, or otherwise manipulating the support member 14C to adjust the position of the housing 20 relative to the power input 18. The configuration shown in FIG. 2 is not intended to be limiting, for example, one or more attachment features 35 may be positioned on any surface of the housing 20 as appropriate to provide a functional positioning of the portable heating unit 10 relative to the power input interface 36 and a power output interface 68 to which it may be connected.

The portable heating unit 10 includes at least one heating element 91 configured to heat air entering the housing 20 through an inlet aperture 12 and exiting the housing through an outlet aperture 24, where the inlet and outlet apertures 12, 24 are defined by the housing 20. Any suitable type of heating element 91 or arrangement of one or more heating elements 91 may be used. For example, the heating element 91 may be an electrical resistance heating element, radiant heating element, ceramic heating element, induction heating element, etc. The portable heating unit 10 may optionally include an air circulating element 95 configured to draw air into the housing 20 through the inlet aperture 12, past the heating element 91 to the outlet aperture 24. The air circulating element 95 may be configured, for example, as a fan or blower, and may be in electrical communication with the power management element 96 and/or the controller 92. The air circulating element 95 and/or controller 92 may be configured such that the air circulating element 95 is actuated concurrently with activation of the heating element 91. In another example, the controller 92 may be configured to delay actuation of the air circulating element 95 until a period of time after activation of the heating element 91, for example, until the heating element 91 achieves a minimum temperature at which forced air circulating through the housing 20 is desired, thus minimizing the power consumed by the air circulating element 95 in operating the portable heating unit 10.

The housing 20 may include an aperture cover 26 configured to cover at least one of the inlet and outlet apertures 12, 24. The aperture cover 26 may be integral to the housing 20, for example, may be molded into the housing 20, or may be selectively removable from the housing 20, for example, to access internal components such as the heating element 91 and air circulating element 95, for maintenance, etc. The aperture cover 26 may include a plurality of primary vents 28 to provide air flow paths through the cover 26 while enclosing the apertures 12, 24 sufficiently to prevent ingression of objects into the housing 20 and/or in contact of objects external to the housing 20 with components located inside the housing 20 such as the heating element 91 and/or air circulating element 95. The primary vents 28 may be adjustable such that the direction of the air flow through the vents 28 may be adjusted. For example, the primary vents 28 may be louvered, hinged, rotatable or otherwise configured such that the direction of air flow through and/or the size of the opening of the vents 28 may be adjusted.

The aperture cover 26 may include one or more supplemental vents 30, where the supplemental vents 30 may be configured to provide supplemental air flow into or out of the housing 20. In the example shown in FIGS. 1 and 2, the supplemental vents 30 are skewed relative to the primary vents 28, such that, for example, heated air flows out of the housing 20 through the primary vents 28 in a direction generally perpendicular to a plane defined by the aperture 24 and flows out of the housing 20 through the supplemental vents 30 generally parallel to the plane defined by the aperture 24. In this manner, the primary and secondary vents 28, 30 cooperate to provide distribution of heated air in multiple directions. Further, by orienting the primary and secondary vents 28, 30 to each other, air flow through the housing 20 is enabled in the event that one or the other of the primary and secondary vents 28, 30 is partially or completely blocked. For example, should the portable heating unit 10 be placed adjacent a surface such that incoming air may be impeded from entering the primary vents 28, incoming air may be supplied to the portable heating unit 10 through the supplemental vents 30 which remain unblocked. In this manner, air flow may be maintained through the housing 20 in situations where the primary vents 28 may become substantially blocked, including, for example, tipping over of the portable heating unit 10 onto its side.

The aperture cover 26 may be rotatable or otherwise repositionable relative to the housing 20 to adjust the direction of air flow through the vents 28, 30. The example shown in FIGS. 1-2 is non-limiting and other configurations of inlet and outlet apertures 12, 24 and aperture covers 26 may be used. For example, the aperture cover 26 may be configured as a screen or mesh to prevent ingression of objects into the housing 20 while providing airflow through the aperture cover 26. The aperture cover 26 may be generally rectangular, conical, or of other shape. The housing 20 may include a plurality of outlet apertures 24 to direct heated air in multiple directions from the housing 20. The housing 20 may include a plurality of inlet apertures 12, including at least one inlet aperture 12 positioned to draw air flow over components such as the controller 92 and/or rechargeable power source 98, to provide selective cooling of these elements.

The rechargeable power source 98 may include, in a non-limiting example, at least one battery configured to be rechargeable by a power supply 62 via a power management element 96 and a power input 18. By way of example, the rechargeable power source 98 may include a fuel cell, a plurality of batteries or battery cells electrically connected to each other. As non-limiting examples, the rechargeable power source 98 may include at least one nickel-cadmium (NiCad) type battery or lithium ion (LI-ion) type battery, such as a lithium iron phosphate battery or a lithium NCM (NiCoMn) type battery, or other suitable type of rechargeable battery. The rechargeable power source 98 may be configured such that in a charged state the rechargeable power source 98 may power the portable heating unit 10 including the heating element 91 for one to six hours, and preferably for at least two hours. The rechargeable power source 98 may be chargeable independent of the portable heating unit 10, such that the rechargeable power source 98 may be charged while removed from the portable heating unit 10, such that a first power source 98 may be used to operate the portable heating unit 10 while the second power source 98 is being charged, or such that a spare charged power source 98 may be maintained to extend operating time of the portable heating unit 10 in the absence of an external power supply 62.

The portable heating unit 10 may be configured such that the rechargeable power source 98 is enclosed in the housing 20 and accessible, for example, via a removable cover (not shown). Alternatively, the portable heating unit 10 may be configured as shown in FIG. 2, including a rechargeable power source 98 configured for insertion into a battery compartment 21 defined by the housing 20 and configured such that the rechargeable power source 98, when inserted into the battery compartment 21, is electrically connected to the electrical circuitry of the portable heating unit 10, including the power management element 96. The removable rechargeable power source 98 may include an integral cover, such that in the installed position in the housing 20, the integral cover encloses the battery compartment 21. The portable heating system 100 may include a plurality of rechargeable power sources 98, such that a depleted rechargeable power source 98 can be replaced with a previously charged rechargeable power source 98.

The controller 92 and power management element 96 may be configured to switch operation of the portable heating unit 10 between the rechargeable power source 98 and the external power supply 62, and/or to charge the rechargeable power source 98 when the portable heating unit 10 is connected to the external power supply 62 via the power input 18. The power management element 96 and/or controller 92 may be configured to control the charging operation, for example, to prevent over charging of the rechargeable power source 98 by monitoring the voltage of the rechargeable power source 98. The controller 92 and/or power management element 96 may include a timing circuit configured to cut off and/or trickle charging current from the power supply 62 after a fixed time, to prevent overcharging of the rechargeable power source 98, where the fixed time may correspond to an expected charging time defined by the type and configuration of the rechargeable power source 98.

The power management element 96 may be configured to monitor the incoming voltage of the power supply 62, and to cut off, e.g., terminate, incoming current from the power supply 62 when incoming voltage fluctuations are detected, including declines in incoming voltage, which may indicate depletion of the external power supply 62. Cutting off incoming current by ceasing charging of the rechargeable power source 98 or switching operation of the portable heating unit 10 to the rechargeable power source 98 may be desired, for example, when the power supply 62 is another battery having a primary function other than charging the rechargeable power source 98. In a non-limiting example, and referring now to FIG. 5, the power supply 62 may include a vehicle battery 72, where the primary function of the vehicle battery 72 is to start the engine (not shown) of a vehicle 70, and where the vehicle battery 72 must retain a minimum voltage to start the vehicle 70. When the vehicle 70 is not running, using the vehicle battery 72 as a power supply 62 to either operator the portable heating unit 10 or charge the rechargeable power source 98 will cause depletion of the vehicle battery charge, which may be measured by the power management element 96 as a drop in incoming voltage from the power output 60. The power management element 96 and/or the controller 92 may be configured to cease charging the rechargeable power source 98 and/or switch over operation of the portable heating unit 10 from the power supply 62 to the rechargeable power source 98 when the incoming voltage reaches a cut-off level, wherein the cut-off level is an incoming voltage level above the minimum voltage level required by the vehicle battery 72 to perform its primary function. In another example, the cut-off level may be defined by an incoming voltage level which is insufficient to effectively activate the heating element 91 to generate heat and/or to effectively charge the rechargeable power source 98.

Referring again to FIG. 5, the vehicle 70 may be, by way of non-limiting example, an automobile, a truck, a trailer, a watercraft, a boat, a submarine, a recreational vehicle, etc. which may define an interior space into which the portable heating unit 10 may be positioned and operated to preheat or heat the interior space, without requiring a power supply 62 external to the portable heating unit 10, and without using the vehicle's power supply. The portable heating unit 10 may be used to generate heat until an alternate source of heat is functioning and/or made available. The interior space of the vehicle 70 may be, for example, the passenger compartment, an engine compartment, a sleeping compartment as in a truck or recreational vehicle, a storage compartment, etc. of the vehicle 70.

In many vehicles, the vehicle alternator 22 or vehicle PCM 71 may prevent current flow from the vehicle battery 72 to the power output 60 when the vehicle is not operating, e.g., when the alternator 22 and/or vehicle engine (not shown) are not operating, or when the voltage output of the vehicle battery 72 is below a predetermined level. In some vehicles the power output 60 may remain powered by the vehicle battery 72 even with the engine off, such that when the portable heating unit 10 is electrically connected to the power output 60 and the vehicle engine is not running, the vehicle battery 72 may provide power to the power output 60, thus making the vehicle battery 72 accessible in an engine off condition to operate the portable heating unit 10 and/or to charge the rechargeable power source 98, and thereby presenting a risk of depleting the vehicle battery below a minimum level required for starting the vehicle 70. This risk is prevented by configuring the power management element 96 and/or controller 92 of the portable heating unit 10 to cease charging of the rechargeable power source 98 if a change in charging voltage from the vehicle battery 72 indicates the vehicle battery 72 has discharged to a cut-off level, where the cut-off level is at least equal or preferably above the voltage level required by the vehicle battery 72 to power primary vehicle functions such as starting the vehicle engine.

Referring to FIGS. 1 and 4, the portable heating unit 10 may be controlled through a user interface 88 in communication with the controller 92. The portable heating unit 10 may be remotely controlled through a transmitting unit 40 in communication with a receiving unit 16, where the receiving unit 16 is in communication with the controller 92. In another example (not shown), the portable heating unit 10 may be configured without the user interface 88, such that the portable heating unit 10 is controllable by the transmitting unit 40 only, via the receiving unit 16. This configuration may be preferred, for example, when it is desirable to simplify the operation and/or construction of the portable heating unit 10 by providing a single point of control in the transmitting unit 40, and/or to enhance portability of the portable heating unit 10 by reducing the size and/or weight of the portable heating unit 10 by eliminating the user interface 88.

The user interface 88 of the portable heating unit 10 may be configured to receive input from a user and to generate a command signal to the controller 92 in response to the user input. The user interface 88 may include, for example, one or more controls 89 and a display 90. In a non-limiting example, the user interface 88 may be configured as a touch interface or touchpad, such that the controls 89 are configured as touch controls. Other configurations of the user interface 88 may be used, including, for example, a liquid crystal display (LCD) in combination with various switches which may include one or more types of switches including toggle, contact, touch, rotary, dial, etc.

The transmitting unit 40, which may also be referred to as a remote control, is configured to generate a command signal in response to an input received from a user via a user interface 44, and to transmit the command signal to the receiving unit 16. Referring to FIGS. 1 and 3, the transmitting unit 40 in the example shown includes a casing 42 which houses a transmitter or transmitter/antenna 54 and a processor 52, and may be powered by a transmitter battery 50. The transmitting unit 40 includes a user interface 44 configured to receive input from a user, and to use the processor 52 and the user input to generate a command signal, such that the command signal may be transmitted using the transmitter 54 to the receiving unit 16. The user interface 44 may include, for example, one or more controls 48 and a display 46. In a non-limiting example, the user interface 44 may be configured as a touch interface or touchpad, such that the controls 48 are configured as touch controls. Other configurations of the user interface 44 may be used, including, for example, a liquid crystal display (LCD) in combination with various switches which may include one or more types of switches including toggle, contact, touch, rotary, dial, etc. The user interface 44 may be configured without a display 46, e.g., with controls 48 only and for reduced size and portability, such that the transmitting unit 40 can be readily transported, for example, in a pocket.

The transmitting unit 40 may optionally include a signal booster or amplifier 56 configured to increase the range of the transmitting unit 40, e.g., the distance from the receiving unit 16 at which the transmitting unit 40 can send a control signal which will be received by the receiving unit 16. The casing 42 of the transmitting unit 40 may be sealed against contaminant ingression including water, and/or may be otherwise configured as a protective casing. The housing 20 may include a compartment 76 for storage of the transmitting unit 40, when the transmitting unit 40 is not in use.

The transmitting unit 40 may optionally include a master control 58, which when in the off position disables sending a command signal from the transmitting unit 40 and/or powers off the transmitting unit 40, to prevent non-intended or inadvertent transmission of a command signal to the portable heating unit 10, for example, for periods of intended non-use, during storage, and/or to conserve power of a transmitter battery 50 (see FIG. 3) which may be included in the transmitting unit 40 to power the transmitting unit 40. The master control 58 may be configured with a lock-out feature (not shown), such as a trigger lock, to further prevent inadvertent activation of the portable heating unit 10, for example, due to non-intended input into the transmitting unit 40, including non-intended input resulting from unintentional or accidental contact of the transmitting unit 40 with another object, for example, when the transmitting unit 40 is transported in a pocket, handbag, briefcase, backpack, etc., and/or to prevent operation of the portable heating unit 10 by non-intended users such as, for example, minor children.

The example configuration of a transmitting unit 40 described herein is not intended to be limiting, and other configurations and/or types of transmitting units may be used. For example, a personal user device, such as a personal digital assistant, smart phone, tablet, etc., may be configured and/or programmed to function as the transmitting unit 40. The personal user device may be used to receive input from a user, programmed to generate a command signal defined by the user input, and configured to transmit the command signal to the receiving unit 16 using, for example, Bluetooth or another wireless communication protocol, via a wireless communication path using the personal user device.

The receiving unit 16 includes a receiver or receiver/antenna 80 configured to receive a command signal from the transmitting unit 40, and a processor 85 for processing and/or communicating the command signal to the controller 92. The receiving unit 16 may be housed in the housing 20 and electrically connected to the controller 92, as shown in FIG. 1. In another example configuration shown in FIGS. 2 and 4, the receiving unit 16 may include a casing 86 housing the receiver 80 and processor 84, and may be electrically connected to the controller 92 via a connector 78, such that the receiving unit 16 may be positioned at a distance from the portable heating unit 10. The receiving unit 16 may be powered by the rechargeable power source 98, or as shown in FIG. 4, may be powered by a separate receiver battery 82, such that the receiving unit 16 may be powered independently of the rechargeable power source 98 and/or the power supply 62. The casing 86 and connector 78 may be sealed or otherwise configured with a protective cover which may be resistant to water intrusion, abrasion, sunlight, etc., such that the receiving unit 16 including the connector 78 are suitable for outdoor use.

In one example, the connector 78 may be of sufficient length to position the receiving unit 16, relative to a structure in which the portable heating unit 10 is placed, at a location intended to minimize interference of the structure with transmission of a command signal from the transmitting unit 40 to the receiving unit 16, where the receiving unit 16 may be placed at a location which may be either inside or external to the structure. In one example, where the structure is a vehicle 70, the connector 78 may be of sufficient length such that the receiving unit 16 may be positioned inside the vehicle 70 on an instrument panel (not shown) of the vehicle 70 or selectively attached to the rear view mirror (not shown), the steering wheel (not shown) or a window (not shown) of the vehicle 70 when the portable heating unit 10 is positioned within the interior space of the vehicle, such as on the vehicle floor. Positioning the receiving unit 16 proximate a vehicle window and/or above the belt line of the vehicle 70 may minimize interference with the signal transmission from a transmitting unit 40 outside the vehicle 70 to the receiving unit 16 inside the vehicle 70, where the signal interference may be caused by the vehicle structure, and especially minimize interference due to metal components of the vehicle structure such as the door and body panels, thus optimizing the signaling range of the transmitting unit 40, e.g., maximizing the signaling distance from which the transmitting unit 40 can transmit a control signal receivable by the receiving unit 16. It would be desirable to extend and/or maximize the signaling distance such that a signal can be transmitted by the transmitting unit 40 at a sufficient distance from the portable heating unit 10 to activate the heating element of the portable heating unit 10 with sufficient time, for example, to preheat the compartment prior to arrival of its occupants. The receiving unit 16 may include an attachment feature (not shown) such as a clip, hanger, hook, suction cup, strap, etc., usable to attach the receiving unit 16 to another object or surface.

In another example, the connector 78 may be of sufficient length to extend the receiving unit 16 a distance away from the portable heating unit 10 positioned inside the vehicle compartment to a location external the vehicle 70, thereby extending the signaling distance from the portable heating unit 10 at which the transmitting unit 40 can transmit a control signal receivable by the receiving unit 16. In one example, the extended length of the connector 78 may be greater than ten feet. In another example, the extended length of the connector 78 is at least twenty feet. The connector 78 may be configured to facilitate routing of the connector 78 through a door interface, such as routing the connector 78 between the sealing interfaces of a door in a closed position. For example, the connector 78 may be configured as a flat type or ribbon type connector. The portable heating unit 10 and/or receiving unit 16 may be configured such that the connector 78 is extendable from and retractable into the housing 20. In one example, the receiving unit 16 may include a retractor element (not shown) from which the connector 78 may be extended and into which the connector 78 may be retracted for storage when not required. The extended length of the connector 78 may be sufficient, for example, to position the receiving unit 16 at a distance away from the portable heating unit 10 such that interference from surrounding structures, including structures in which the portable heating unit 10 may be positioned, may be minimized. In one example, the receiving unit 16 may be configured with a connector 78 of sufficient length to position the receiving unit 16 in a location sufficiently elevated from the ground such that signal interference from surrounding structures including topographical interference due to variations in the surrounding landscape is decreased. The housing 20 may include one or more compartments 76, where one of the compartments may be configured to receive the retracted connector 78 and/or to store a non-extended portion of the connector 78 and/or the receiving unit 16 when not in use.

Referring again to FIGS. 1 and 4, the controller 92 may be in communication via electrical circuitry with each of the receiving unit 16, the power input 18, a master control 74, the user interface 88, the heating element 91, the timing element 94, the air circulating element 95, the power management element 96, the rechargeable power source 98, and one or more sensors 99, and in wireless communication with the transmitting unit 40 via the receiving unit 16 and the wireless communication path 38. The portable heating unit 10 may include a controller battery 93 in electrical communication with the controller 92, such that the controller 92 may be powered independently of the rechargeable power source 98 and/or the power supply 62, and such that the controller 92 may be operated when the rechargeable power source 98 is substantially discharged. The controller 92 may include, for example, a central processing unit (CPU) (not shown), a read-only memory (ROM) (not shown), and a random-access memory (RAM) (not shown), each configured as required such that the controller 92 can perform functions as described herein.

In use, the controller 92 receives command signals from the user interface 88, and/or from the transmitting unit 40 via the receiving unit 16, and responds by generating a corresponding controller signal or signals to the appropriate element and/or elements of the portable heating unit 10. Controller signals generated by the controller 92 may include, for example, controller signals to activate or deactivate the heating element 91, to activate or deactivate the air circulating element 95, to generate information for display on the display 90, to charge or discontinue charging the rechargeable power source 98, to program, activate or deactivate the timing element 94, to communicate with one or more of the master control 74, the power management element 96, the receiving unit 16 and one or more of the sensors 99. The examples of controller signals which may be generated by the controller 92 is not intended to be limiting, for example, the controller 92 may be configured to generate other controller signals not listed here but understood to be required to control the portable heating unit 10 and components thereof to perform various functions of the portable heating unit 10 as described herein.

One or more of the controls 89 of the user interface 88 and/or the controls 48 of the transmitting unit 40 may have a dedicated use, e.g., may be configured in communication with the controller 92 such that when the control 48, 89 is activated, the controller 92 activates the portable heating unit 10 in a predetermined mode. For example, one of the controls 48, 89 may be configured to activate the portable heating unit 10 to operate in a “continuous mode” such that the portable heating unit 10 will be activated to generate heat until the rechargeable power source 98 is depleted, e.g., until the rechargeable power source 98 is substantially and/or completely discharged. Another of the controls 48, 89 may be configured to activate the portable heating unit 10 to operate in a “preheat mode” such that the portable heating unit 10 will be activated to generate heat for a specified amount of time, then shut off. Another of the controls 48, 89 may be a timer control to input a start time to activate the portable heating unit 10, where the start time may be a clock time or a delay time, which may be stored and/or executed by the timing element 94 and/or the controller 92. Another of the controls 48, 89 may be a temperature selection control, which may be configured for selection between two or more of a “low heat,” “medium heat,” and “high heat” setting, or may be configured for input of one or more temperature settings, such as a target ambient temperature setting, expressed in degrees, such as degrees-Fahrenheit or degrees-Celsius, or a target ambient temperature range including high and low temperature limits. Activating the portable heating unit 10 to generate heat may include, for example, activating the heating element 91 to generate heat, activating the air circulating element 95 to circulate air through the housing 20, and activating the controller 92 to monitor sensors 99 for various operating conditions, including operating conditions of the portable heating unit 10 that may trigger an automatic shut-off of the portable heating unit 10 and/or the heating element 91, such as operating conditions indicating an overheat condition, a tip-over condition, etc. One of the controls 48, 89 may be a “charge only” control, which may command the portable heating unit 10 and/or power management element 96 to access an external power supply 62 only if required to charge the rechargeable power source 98, and such that the external power supply 62 is not used to power the heating element 91.

One or both of the user interfaces 44, 88 may be configured such that a user can input various settings for response by the controller 92. For example, the user may input start and stop times for activating and deactivating the portable heating unit 10, which may be input as clock times and/or as a delayed start time and a run time, after which run time the portable heating unit 10 is shut off. The plurality of sensors 99 may include a temperature sensor 99 configured to measure the ambient temperature proximate the portable heating unit 10. The user may input a target temperature setting, such that when the portable heating unit 10 has heated the space around the portable heating unit 10 sufficiently that the temperature sensor 99 indicates the target temperature has been achieved, the controller 92 deactivates at least the heating element 10. In another example, the controller 92 may be configured to cyclically operate the portable heating unit 10 to maintain the ambient temperature between a lower temperature limit and the target temperature, by deactivating the heating element 10 after the target temperature is achieved as indicated by the temperature sensor 99, reactivating the heating element 10 when the ambient temperature sensed by the temperature sensor 99 decreases to the lower temperature, reactivating the heating element 10 until the ambient temperature again reaches the target temperature, and so forth.

The portable heating system 100 may be configured such that a user may input or otherwise associate a set of one or more commands with a program identifier using, for example, the user interface 88 or the transmitting unit 40, such that the set of one or more commands are stored with the associated program identifier as a program by the controller 92. The user may subsequently use one of the user interface 88 of the portable heating unit 10 or the user interface 44 of the transmitting unit 40 to activate the stored program, by inputting the associated program identifier to the user interface 44, 88, or for example, by selecting the associated program from a menu provided by the user interface 44, 88. The portable heating unit 100 may be pre-configured with a plurality of programs for user convenience, including, for example, a program to activate the heating element 91 at a preset time and temperature, a program to immediately activate the heating element 91, a program to activate the heating element for a predetermined amount of time, etc.

The plurality of sensors 99 may include a temperature sensor, as described previously and other sensors configured to provide inputs to the controller 92, such that the controller 92 may generate controller signals in response to the sensor inputs. For example, a sensor 99 may be configured to sense tip-over of the portable heating unit 10 and to provide an input to the controller 92 to automatically shut off the portable heating unit 10. Another sensor 99 may be configured to sense the operating temperature of the heating element 91, and input the operating temperature to the controller 92, which may be configured to automatically shut off the portable heating unit 10 when the operating temperature exceeds a preset limit, for example, to prevent overheating of the portable heating unit 10.

Optionally, as shown in FIGS. 1 and 4, the portable heating unit 10 may include a master control 74, which may be configured, for example, as a master on/off switch for the portable heating unit 10, and which in the off position prevents activation of the portable heating unit 10 and/or elements therein, including the heating element 91, by either or both of the transmitting unit 40 and the user interface 88. The master control 74 in the off position may deactivate one or both of the user interface 88 and the receiving unit 16. The master control 74 may be placed in the off position, for example, for periods of intended non-use of the portable heating unit 10 such as during storage of the portable heating unit 10, and/or to prevent non-intended or inadvertent activation of the portable heating unit 10. The master control 74 may include a lock-out feature (not shown), such as a trigger lock, to further prevent inadvertent activation of the portable heating unit 10, for example, due to non-intended input into one of the user interface 88 and the transmitting unit 40, including non-intended input resulting from unintentional or accidental contact of the user interface 88 and/or the transmitting unit 40 with another object, and/or to prevent operation of the portable heating unit 10 by non-intended or unauthorized users such as, for example, minor children.

The portable heating unit 10 may be configured for portability. For example, the housing 20 may be made of a lightweight material to minimize the overall weight of the portable heating unit 10. The housing 20 may include one or more storage compartments 76 for storing components of the portable heating unit 10 when the components are not in use and/or when transporting the portable heating unit 10. The compartments 76 may be configured to store, for example, one or more of the power input 18 or a plurality of various types of power inputs 18 if so provided for interface with various types of power outputs 60, adapters 66, the receiving unit 16, and the transmitting unit 40. In one example, one of the compartments 76 may be configured to store a rechargeable power source 98. In this example, the compartment 76 may be configured as a charging station such that as stored, the rechargeable power source 98 may be electrically connected to the power management element 96 and recharged in the stored position when the portable heating unit 10 is connected to a power supply 62.

The portable heating unit 10 may include one or more support members 14, which may be configured for carrying the portable heating unit 10 during transport, for attachment and/or positioning of the portable heating unit 10 relative to another object or surface, and/or for stabilizing the position of the portable heating unit 10 during use. In the non-limiting examples shown, a support member 14A may be configured as a handle for carrying the portable heating unit 10. The support member 14A may be rotatably mounted, hinged, tiltable or otherwise repositionable relative to the housing 20 such that the support member 14A may be repositioned to support and/or stabilize positioning of the portable heating unit 10 during use. By way of example, the support member 14A may be configured as a hanger, clip, hook, strap, etc., usable to attach the portable heating unit 10 to another object or surface or to suspending the portable heating unit 10 from another object. For example, the support member 14A may be configured to suspend the portable heating unit 10 from the rear view mirror (not shown) of a vehicle 70, such that the housing 20 is not in contact with any interior surfaces of the vehicle 70 when in use.

By way of example, a support member 14B may be configured for stabilizing the position of the portable heating unit on a resting surface (not shown), e.g., where a “resting surface” as that term is used herein, is a surface on which the portable heating unit 10 is placed in a standalone configuration during use. A resting surface may be, but is not required to be, a relatively flat surface. Examples of resting surfaces may include, by way of non-limiting example, the ground, a floor, a counter-top, a surface of a piece of furniture such as a table or chair, an interior surface of a vehicle including, for example, the instrument panel, rear decking or floor, a container surface such as a crate or box, etc. The supporting member 14B may be configured to include a generally flat surface which may extend in proportion beyond the perimeter of the housing 20, so as to stabilize the portable heating unit 10 on the resting surface. The supporting member 14B may be weighted to stabilize the position of the portable heating unit 10 relative to the resting surface, and/or to prevent tip-over of the portable heating unit 10. The supporting member 14B may be configured to conform to the resting surface, for example, the supporting member 14B may be configured as a pliable and/or weighted mat which may conform to a non-flat resting surface to stabilize the position of the portable heating unit 10. The supporting member 14B may be adjustably attached to the housing 20, such that the position of the housing 20 can be adjusted relative to the supporting member 14B. For example, the supporting member 14B may be rotatably attached to the housing 20 such that the housing 20 may be rotated relative to the supporting member 14B to redirect heated air flow without relocating the portable heating unit 10 relative to the resting surface.

As described previously, a supporting member 14C may be configured for attachment to a power output 60 and/or power output interface 68, and may be repositionable such that the position of the portable heating unit 10 relative to the power output 60 may be adjusted by repositioning the supporting member 14C.

The example configurations described for support members 14 including support members 14A, 14B, 14C are not intended to be limiting, and it would be understood that other configurations of support members 14 may be used to support, position, transport and/or stabilize the portable heating unit 10 in use. For example, a support member 14 may be configured as a telescoping and/or extendable support member 14 reconfigurable to adjust the distance of the housing 20 relative to the support member 14, so as to adjust the height and/or position of housing 20 and heated air flowing therefrom. The support members 14 and/or housing 20 may be configured such that at least one of the support members 14 is detachable from the housing 20 and/or replaceable with another of the support members 14 as required for positioning and/or stabilizing the portable heating unit 10 in various use environments. For example, the support member 14C may be attached to the housing 20 when the portable heating unit 10 is in use in a vehicle interior space, then may be detached and replaced with a support member 14B when the housing 20 is located in use on a resting surface, such as the floor of a tent or a table top, where stable positioning of the portable heating unit 10 on the resting surface is desired.

The portable heating system 100 described herein provides numerous advantages. For example, the portable heating system 100 may be used to heat an interior space of a vehicle until the vehicle heater is functional to provide heat, may be remotely controlled to preheat the vehicle, without retrofitting or modifying the vehicle electrical system, and without using the vehicle power supply, and may be used as a supplemental heater in a vehicle, either independently or connected to the vehicle power system. The rechargeable power source 98 may be recharged by connecting the portable heating unit 10 to the vehicle power supply 62 or to another power supply 62 such as a ground power supply (wall outlet), a generator, a solar panel, etc., and such that the portable heating system 100 may be used independently of, e.g., without electrical connection to, the vehicle 70. The portable heating system 100 may be used to heat interior spaces such as tents, cabins/cottages, garages, worksites, etc. and/or exterior spaces such as campsites, decks, worksites, etc. The portable heating system 100 may be remotely controlled via the transmitting unit 40 to preheat these spaces until, for example, other heat sources which are typically attended heat sources such as wood stoves, fireplaces, campfires, etc. are functional to provide heat, and/or the portable heating system 100 may be used as a supplemental heat source to other heat sources.

While the best modes for carrying out the invention have been described in detail, those familiar with the art to which this invention relates will recognize various alternative designs and embodiments for practicing the invention within the scope of the appended claims.

1. A portable heating system comprising:
a rechargeable power source;
a heating element; and
a power management element configured to selectively electrically connect the heating element to the rechargeable power source to power the heating element to generate heat.

2. The system of claim 1, wherein the rechargeable power source is one of a lithium ion type battery and a nickel-cadmium type battery.

3. The system of claim 1, further comprising:
a power input configured to selectively electrically connect an external power supply to the power management element;
wherein the power management element is configured to:
charge the rechargeable power source using the external power supply; and
switch the electrical connection of the heating element between the rechargeable power source and the external power supply.

4. The system of claim 3, wherein:
the external power supply is configured as a vehicle power supply; and
the power input is configured to be selectively electrically connected to the vehicle power supply.

5. The system of claim 3, wherein:
the power input includes a power input interface configured to be selectively electrically connected to the external power supply; and
the power input interface is configured as one of a universal serial bus (USB) plug and a cigarette lighter plug.

6. The system of claim 3, further comprising:
a housing configured to house the power management element, the heating element, and the rechargeable power source;
wherein the power input includes:
a power input interface configured to be selectively electrically connected to the external power source; and
a connector configured to electrically connect the power input interface to the power management element; and
wherein the connector is configured to position the power input interface a distance from the housing.

7. The system of claim 6, wherein the connector is configured to position the power input interface a distance at least ten feet from the housing.

8. The system of claim 6, wherein the connector is configured as a retractable connector.

9. The system of claim 6, wherein the power input is configured for outdoor use.

10. The system of claim 3, wherein the power management element is configured to:
monitor incoming voltage of the external power supply; and
terminate use of the external power supply when the incoming voltage reaches a cut-off level.

11. A portable heating system comprising:
a controller;
a rechargeable power source;
a heating element electrically connected to the rechargeable power source;
a receiving unit in electrical communication with the controller and configured to receive at least one command signal from a transmitting unit;
the transmitting unit configured to transmit the at least one command signal to the receiving unit via a wireless communication path;
wherein the controller is configured to receive the at least one command signal from the receiving unit and to generate a controller signal corresponding to the at least one command signal; and
wherein the at least one command signal includes a command signal to activate the heating element to generate heat.

12. The portable heating system of claim 11, further comprising:
a housing configured to house at least the controller, the heating element, and the rechargeable power source;
a connector configured to electrically connect the receiving unit to the controller; and
wherein the connector is configured to position the receiving unit a distance from the housing.

13. The system of claim 12, wherein the connector is configured to position the power input interface a distance at least ten feet from the housing.

14. The portable heating system of claim 11, wherein the transmitting unit includes a signal booster to boost the command signal.

15. The portable heating system of claim 11, further comprising:
a housing configured to house at least the controller, the heating element, and the rechargeable power source;
wherein the housing includes a compartment configured to store the transmitting unit.

16. The portable heating system of claim 11, further comprising:
a power management element; and
a power input configured to selectively electrically connect an external power supply to the power management element;
wherein the power management element is configured to:
charge the rechargeable power source using the external power supply; and
switch the electrical connection of the heating element between the rechargeable power source and the external power supply.

17. A portable heating system adaptable to preheat an interior space of a vehicle, the system comprising:
a controller;
a rechargeable power source;
a heating element electrically connected to the rechargeable power source;
a power management element configured to selectively electrically connect the heating element to the rechargeable power source to power the heating element to generate heat;
a receiving unit in electrical communication with the controller and configured to receive at least one command signal from a transmitting unit;
the transmitting unit configured to transmit the at least one command signal to the receiving unit via a wireless communication path;
wherein the controller is configured to receive the at least one command signal from the receiving unit and to generate a controller signal corresponding to the at least one command signal; and
wherein the at least one command signal includes a command signal to activate the heating element to generate heat.

18. The portable heating system of claim 17, further comprising:
a power input configured to selectively electrically connect a vehicle power supply to the power management element;
wherein the power management element is configured to:
monitor incoming voltage of the vehicle power supply;
charge the rechargeable power source using the vehicle power supply;
switch the electrical connection of the heating element between the rechargeable power source and the vehicle power supply; and
terminate use of the vehicle power supply when the incoming voltage reaches a cut-off level;
wherein the cut-off level is above the vehicle power supply voltage required to start the vehicle.

19. The portable heating system of claim 17, further comprising:
a housing configured to house at least the controller, the rechargeable power source, the power management element, and the heating element;
a power input configured to selectively electrically connect a vehicle power supply to the power management element;
wherein the vehicle defines a power output interface electrically connected to the vehicle power supply;
wherein the power input includes a power input interface configured to be selectively connected to the power output interface;
a support member operatively connected to the housing;
wherein the support member includes the power input and is configured to position the housing relative to the power output interface when the power input interface is connected to the power output interface;
wherein the support member is repositionable to adjust the position of the housing relative to the power output interface between a first position and at least a second position.

20. The portable heating system of claim 17, further comprising:
at least one sensor configured as at least one of:
an overheat sensor configured to detect an overheat condition of the portable heating system and to send a shut-off signal to the controller in response; and
a tip-over sensor configured to detect send a tip-over condition of the portable heating system and to send a shut-off signal to the controller in response;
wherein the controller is configured to automatically deactivate the heating element upon receipt of a shut-off signal from the at least one sensor.
